(19) United States
(12) Patent Application Publication
(10) Pub. No.: US 2018/0342004 A1
(43) Pub. Date: Nov. 29, 2018

(54) CUMULATIVE SUCCESS-BASED RECOMMENDATIONS FOR REPEAT USERS

(71) Applicant: MICROSOFT TECHNOLOGY LICENSING, LLC, Redmond, WA (US)

(72) Inventors: Elad Yom-Tov, Hoshaya (IL); Assaf Hallak, Tel Aviv (IL); Noam Koenigstein, Raanana (IL)

(21) Appl. No.: 15/605,525

(22) Filed: May 25, 2017

(51) Int. Cl. G06Q 30/06; G06Q 30/02; G06N 7/08

(52) U.S. Cl. CPC G06Q 30/0631; G06N 7/08; G06Q 30/0217; G06Q 30/0224

(57) ABSTRACT

Computerized systems and methods are provided for determining cumulative success-based recommendations for repeat users. One such method includes determining user and item latent-features based on matrix factorization applied to matrices that include recommendation and feedback events. The feedback events indicate previously provided user preferences for at least a portion of the items. An item-recommendation policy is determined based on a cumulative metric that includes an expected value for the accumulation of stochastic user-item rewards associated with future (or subsequent) recommendations. The accumulation of the rewards is based on the user latent-features, the item latent-features, and the previous rewards included in the feedback events. Machine learning, such as reinforcement learning (RL), is employed to determine the item-recommendation policy based on the feedback events. A recommendation is provided to a user based on the determined recommendation policy, the user latent-features for the user, and the item latent-features of the recommended items.

### BACKGROUND

Computer recommendation systems conventionally function to provide users with item recommendations that are based on the user's preferences with respect to other items. Such recommendation systems are often deployed in electronic commerce (e-commerce) platforms, e.g., online marketplaces, online retailers, and digital-content streaming providers. Often, such systems “observe” a user's feedback directed at some items included in an online catalog. These systems attempt to discern the preferences of the user based on a history of such feedback-driven observations. In a current interaction with the user, the system recommends additional items to the user based on the user's observed history and the user's discerned preferences. In the current interaction with the user, such systems typically provide a current recommendation based on optimizing an expected value of return (i.e., a success) associated with the current recommendation. In other words, for a current interaction, a particular recommendation determined and provided by the recommendation system is more likely to be accepted by the user than alternative recommendations that could have been provided.

For instance, in a current interaction with an online content provider, a recommendation system provides a returning user with a recommendation for movies, music, or games that are available for online streaming. The recommendations are based on the user's preferences for other items determined via observations of the user previously purchasing, watching, and/or reviewing the other items. In particular, a common approach utilized by conventional recommendation systems, is to recommend items that are determined to have an expected maximal-value associated with the current recommendation, e.g., the system specifically recommends a movie that is associated with a maximal likelihood for the user to purchase it and/or positively review it, in response to being provided the current recommendation. However, the conventional recommendation systems are problematic because they do not ensure that value is maximized over the long term. Rather, the conventional recommendations may maximize the current interaction, at the expense of the long term benefits to the recommending party.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Aspects of this disclosure relate to technologies for providing cumulative success-based recommendations for repeat users. That is, the technologies provide a user with recommendations for items, including physical items and digital content, such as movies, books, music, and products. The user is a repeat user, e.g., the user receives multiple recommendations distributed over multiple interactions. An item that is recommended to the user in a specific interaction is based on a cumulative success of the multiple recommendations, rather than the success associated with only the specific interaction.

Briefly, the success associated with a specific interaction refers to whether the user's actions are favorable, in view of the associated recommendation, e.g., did the user buy the recommended item, positively review the recommended item, view/listen to the recommended item, or provide another such reward in view of the recommended item. In various embodiments, the success associated with recommending a specific item to a specific user in a specific interaction is referred to a user-item reward. Thus, a cumulative success for the repeat user may refer to a summation, or accumulation of the user-item rewards associated with each of the multiple interactions. Basing items to recommend in a specific interaction on a cumulative success is contrasted from conventional methods, which typically base recommendations on the success (or reward) associated with only the specific interaction.

In one embodiment, a method includes determining features that characterize each of the potentially recommended items, i.e., item features, and features that characterize the item preferences of the user, i.e., user features. More particularly, the user features characterizes the user's preferences for the item features. Thus, a user-item reward may be indicative of the features of the specific user (i.e., the user's preferences) and the features of the specific item. The user features and the item features may be latent-features of the user and items respectively.

In this embodiment, the user features and the item features are determined based on one or more feedback events. That is, the user and item features are based on previously provided recommendations and the user's favorable or dis-favorable actions in response to the recommendation. For example, the feedback events include previously provided user-item rewards.

The method also includes determining a recommendation policy based on an expected value of the cumulative success associated with multiple interactions. The expected value of the cumulative success is based on the user features, the item features, and the user-item rewards. Once determined, the method may employ and/or implement the recommendation policy to provide the user with one or more recommendations.

Briefly, a recommendation policy may include one or more rules, conditions, algorithms, models, and/or heuristics that are employed to determine which item to recommend to the user in a specific interaction. The recommendation policy is determined such that the cumulative success, rather than the success associated with the specific interaction, is maximized or at least increased.

In some embodiments, the recommendation policy may include, or at least be implemented via, computer instructions or software routines for determining a recommendation. As discussed throughout, the determining of a recommendation policy may employ machine learning or other statistical measures to determine aspects of a recommendation or specific rules or logic for determining a recommendation.

More particularly, the user and item features may be determined via matrix factorization (MF) methods. A recommendation policy may be determined based on a cumulative metric, as well as the user and item features. The cumulative metric includes a stochastically expected value for the accumulation of stochastic user-item rewards associated with future or subsequent recommendations. The accumulation of the rewards is based on the user features, the item features, and the previous user-item rewards included in the feedback events.

In some embodiments, machine learning, such as reinforcement learning (RL), may be employed to determine the recommendation policy based on the feedback events and corresponding previous recommendation events. A recommendation may be provided to a user based on the determined recommendation policy, as well as the user features for the user and the item features of the recommended items.

In some embodiments, a method may include determining a current cumulative value associated with a current recommendation policy. For instance, an on-policy analysis of user-item data may be employed. The user-item data includes previous recommendation events and associated feedback events that are each associated with a user and one or more items. An action-value function, of a reinforcement model (RM), may be determined based on the user-item data. The RM may be based on reinforcement learning and include a state space, an action space, and a reward space based on the user-item data. The action-value function may be based on state-action pairs included in the RM. An off-policy analysis of the user-item data may be deployed to generate an updated recommendation policy. A comparison between the current cumulative value and an updated cumulative value of the updated recommendation policy may be generated. If the comparison is favorable for the updated recommendation policy, the updated recommendation policy may be deployed in a “live” online system.

In another embodiment, a method includes aggregating user-item data. The user-item data includes recommendation data structures (DSs) and feedback DSs. The recommendation DSs encode previous recommendations that were previously provided to users. The feedback DSs encode corresponding preferences of the users for the recommended items. User DSs, encoding user latent-features, may be generated. Similarly, item DSs, encoding the item latent-features, may be generated. A decision-process DS may be generated based on the recommendation DSs, the feedback DSs, the user DSs, and the item DSs. For instance, the decision-process DS may encode a Markov Decision Process (MDP). A recommendation policy may be generated based on the decision-process DS and a cumulative metric that includes an expected value for the accumulation of stochastic and/or subsequent rewards. For instance, reinforcement learning (RL) may be applied to increase an evaluation of the cumulative metric with respect to other recommendation policies. The recommendation policy may be employed to provide at least a portion of the users with subsequent recommendations.

### BRIEF DESCRIPTION OF THE DRAWINGS

Aspects of the disclosure are described in detail below with reference to the attached drawing figures, wherein:

FIG. 1 is a block diagram of an exemplary computing environment suitable for use in implementing embodiments of the present disclosure;

FIG. 2A is a block diagram illustrating an exemplary cumulative success-based system in which some embodiments of the present disclosure may be employed;

FIG. 2B provides a graphical representation of trajectories within a reinforcement model that is consistent with the various embodiments;

FIGS. 3-6 illustrate flow diagrams showing methods for providing cumulative-success-based recommendations in embodiments of the present disclosure; and

FIG. 7 is a block diagram of an exemplary computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

As used herein, the term “item” may refer to any to discrete, combination, collection, set, or bundle of merchandise, products, goods, services, content, options, offers, or the like that may be available and/or offered for purchase, lease, rent, trade, loan, or selection within an online system, marketplace, platform, website, ecosystem, or the like. Items may include physical items; information or data encoded in digital or other formats (e.g., digital content); or services, offers, or options offered via various parties. For instance, an item may be a physical item available for selection within a catalog, inventory, or database associated with an online electronic commerce (e-commerce) website.

An item may include digital content available for downloading, streaming, or on-demand delivery from a content provider. Such items may include, but are not limited to video content, audio content, textual content, or other multimedia content. Thus, an item may include an individual movie, television show, online video, musical album, song, performance, book (textual or audio), video and/or audio podcast, blog, magazine, or the like, as well as any collection or combination thereof, that is available for online delivery. The item may include static or dynamic content. For instance, the item may include interactive content such as an online video or text-based game. In some embodiments, the item may include virtual reality (VR)-related content and/or augmented reality (AR)-related content.

In some embodiments, an item may include an offer and/or an option, such as but not limited to a promotional offer. An item may include an offer to purchase various products and/or services. For instance, an item may include an offer to make a reservation, such as but not limited to an airline reservation, a lodging reservation, a rental vehicle reservation, a hotel reservation, or the like. In some embodiments, an item may include an offer and/or an option to purchase tickets to an event, such as but not limited to, a sporting event, musical performance, theatrical performance, or the like.

As used herein, the term “item-provider” may be used to refer to a party, organization, and/or an individual or combination thereof that makes items available for selection to one or more users of an online system, such as but not limited to online marketplaces, platforms, websites, ecosystems, or the like.

As used herein, the term “item recommendation,” or simply “recommendation,” may be used to refer to one or more indications of each item included in a determined subset of items included in a catalog, collection, database, or set of available items. That is, an item recommendation may include an indication of one or more items that are available for a user's selection. For instance, an item recommendation may include a list of indications, such as but not limited to product names, content titles, content authors, service providers, price, cost, or the like, of each item included in the determined subset of the items that are available for user selection. In at least one embodiment, an item recommendation includes a list of one or more movie titles, music titles, video game titles, or names (or other unique identifiers) of physical items that the user may select from. For instance, an item recommendation may include a list of three movie titles available on-demand for downloading or online streaming. An item recommendation may be considered to be associated with the one or more items indicated in the item recommendation. In various embodiments, a particular item recommendation is targeted and/or provided to a particular user. Therefore, in addition to being associated with one or more items, an item recommendation may be associated with the targeted user that has provided the item recommendation.

In various embodiments, the subset of available items to include indications of in an item recommendation may be determined via a tailoring and/or targeting of one or more specific users. More specifically, a specific item recommendation may be associated with a specific user. Accordingly, separate item recommendations may be associated with separate users. For instance, a first item recommendation may be associated with a first user and a second item recommendation may be associated with a second user. In addition to associations with users, item recommendations may be associated with instances in time, e.g., time-slices or time-samples. Accordingly, separate item recommendations may be associated with the same user at separate time-samples. For instance, the first item recommendation may be associated with the first user and a first time-sample, while a third item recommendation may be associated with the first user and a second time-sample. Furthermore, a specific item recommendation may be associated with the one or more items, of which the indications of, are included.

An item recommendation may be encoded in structured and/or unstructured data. Such structured and/or unstructured data encoding a specific item recommendation may be referred to as an “item-recommendation data structure,” or simply a “recommendation data structure.” In some embodiments, an item recommendation data structure (DS) may be an “item-recommendation event,” or simply a “recommendation event.” In some embodiments, an item-recommendation event or another item-recommendation DS includes a 3-tuple, for instance: (User_ID, Item_ID, timestamp), where User_ID is a unique identifier (i.e., an indication) that uniquely identifies the associated user, Item_ID is a unique identifier (i.e., an indication) that uniquely identifies the associated item, and timestamp is a value and/or string indicating the date and/or time (i.e., time-slice or time-sample) associated with the encoded item recommendation. In various embodiments, when more than one item is included in an item recommendation, the encoding may be accomplished via an N-tuple, where N is a positive integer greater than 3, e.g., (User_ID, Item_1_ID, Item_2_ID, Item_3_ID, . . . Item_N−2_ID, timestamp). The item recommendation may be encoded in data structures other than the 4-tuple discussed above.

Although some embodiments discussed herein refer to the user selecting items for purchase or consumption, other embodiments are not so constrained. For instance, a user may be enabled to select an item included in or not included in an item recommendation for lease, rent, trade, loan, or the like. A user may be enabled to select an item to engage the services of a service provider, such as but not limited to an online service provider. A user may be enabled to select an item for access or consumption of any information/data encoded in the item.

As used herein, the term “user-item feedback interaction” may be used to refer to user interaction with an online system, where a specific user provides a feedback signal in response to a specific item. Such a feedback signal may include an action that is associated with and/or directed at the specific item. The feedback signal is indicative of the specific user's preference for the specific item. Such a feedback signal may include but is not otherwise limited to the user purchasing the item, consuming (e.g., watching, listening, viewing, or reading) the item, reviewing the item, rating the item, selecting the item, or otherwise providing a positive, negative, or neutral indication associated with the user's preference for item. A user-item feedback interaction may be in response to the item being included in a provided item recommendation, or may be independent and/or separate from any such item recommendation, i.e., a user may select for viewing and provide a rating of a movie in absence of any item recommendation that includes the title of the movie.

In some embodiments, the provided feedback signal may include or is otherwise mapped to a preference value that indicates the user's positive, negative, or neutral preference for the item. Such a preference value may include but is not otherwise limited to a real, rational and/or integer value indicating the preference. The preference value may be a positive value or a negative value. The value may be a binary value (e.g., 0/1 or −1/+1) indicating the user's binary positive/negative (or neutral) preference for the item. The value may be a rating (e.g., four out of five stars) indicating the user's preference value. The value may be normalized to be constrained to virtually any range of values, such as but not limited to the following ranges: [−1, +1], [0, 1], [0, 10], [0, 100], or the like. Such a preference value may be referred to as a “reward signal,” where the reward signal indicates the user's preference for the item. Thus, a specific user-item feedback interaction is associated with a specific user (i.e., the user providing the indication of the reward signal), a specific item (i.e., the item that the reward signal is directed at), and the reward signal indicating the user's positive, negative, or neutral preference for the item. Thus, a user-item feedback interaction couples a specific user with and a specific item, where the strength of the coupling is based on the reward signal.

A user-item feedback interaction may be encoded in structured and/or unstructured data. Such structured and/or unstructured data encoding a specific user-item feedback interaction may be referred to as a “user-item feedback data structure,” or simply a “feedback data structure.” In some embodiments, a user-item feedback data structure may be a “user-item feedback event,” or simply a “feedback event.” A user-item feedback event or another feedback data structure (DS) may include a 4-tuple: (User_ID, Item_ID, reward signal, timestamp), where User_ID is a unique identifier that uniquely identifies the user, Item_ID is a unique identifier that uniquely identifies the item, reward signal (or simply the reward) is the preference value for the identified user's preference for the identified item, and timestamp is a value and/or string indicating the date and/or time associated with the encoded user-item feedback interaction. Because the reward signal encodes an indication of a preference provided by the associated user (identified via User_ID_) for the associated item (identified via Item_ID), the reward signal may be referred to as a “user-item reward.” The user-item feedback interaction may be encoded in feedback DSs other than the 4-tuple discussed above.

In the various embodiments, at least a portion of the user-item feedback events, as discussed below, may be associated with, correlated with, and/or corresponding to an item-recommendation event. The association may be a one-to-one association. For instance, a user-item feedback event may be generated in response to an item-recommendation event. That is, a user may be provided with an item recommendation that is encoded in an item-recommendation event. In response to the item recommendation, the user may interact with one or more of the recommended items (e.g., selecting and/or purchasing the item), generating a user-item feedback event that is encoded in a user-item feedback event. Thus, the item-recommendation event and the resulting user-item feedback event may be associated, correlated, and/or a correspondence may be generated.

As used herein, the terms “user-item data” or “user-item dataset” include a collection or set of multiple user-item feedback events (or other user-item feedback data structures) and/or multiple item-recommendation events (or other item-recommendation data structures) associated with multiple users and multiple items. Note that the user-item data encodes previous item recommendations and associated previous user-item feedback interactions (e.g., previous user-item rewards). In various embodiments, user-item data may be aggregated into sequential time-steps, time-samples, time-slices, or the like. That is, the user-item data may be arranged in sequential steps. The sequential steps may be indexed via an integer index. For instance, an initial item-recommendation event and the corresponding user-item feedback event may each be indexed via index t, where t=0, 1, 2, . . . p−1, where p is the number of sequential item-recommendation events and associated user-item feedback events. Thus, user-item data may include a time-ordered sequence of item-recommendation events and associated user-item feedback events.

The various embodiments herein are directed towards recommendation systems and methods, i.e., systems and methods that provide one or more item recommendations to users of an online system, marketplace, platform, website, or ecosystem. Essentially, the various embodiments employ long-term recommendation strategies when providing item recommendations to repeat users. More specifically, the various embodiments employ user-item data (e.g., user-item feedback events) to determine tradeoffs between long-term and short-term recommendation strategies, i.e., to determine item-recommendation policies, or simply, recommendation policies, that increase the overall or cumulative success of providing item recommendations to repeat users. The embodiments employ the determined item-recommendation policies to provide enhanced item recommendations, which are specifically tailored and/or targeted to each user, such that the system's cumulative success is increased.

In addition, the various embodiments iteratively update the determined item-recommendation policies based on the accumulation of provided item recommendations and observations of the user's response to the item recommendations. That is, the embodiments adapt the tradeoffs between long-term and short-term recommendation strategies based on the dynamically-learned preferences of the users. Furthermore, the various embodiments provide a workflow that is enabled to evaluate a cumulative success of a current item-recommendation policy, generate an updated item-recommendation policy based on a stochastically-expected cumulative success of its recommendations, and evaluate the performance of the updated item-recommendation policy, as compared to the current item-recommendation policy, prior to deploying the updated policy in an online (i.e., “live”) e-commerce system. Such a workflow provides a measure of the expected improvement of the updated item-recommendation policy as compared to the current item-recommendation policy. The workflow also provides assurances that the updated item-recommendation policy will, if deployed in a “live” system, provide an improvement (and not a reduction) in the cumulative success of the “live” system.

Typically, online marketplaces, e-commerce websites, ecosystems, and other online platforms enable users to select one or more items for purchase and/or consumption, as well as enable the users to provide one or more user-item feedback interactions directed at the selected items (i.e., express a positive, negative, or neutral item preference). Such online platforms often employ conventional recommendation systems that recommend items to their users for selection. Conventional systems, such as but not limited to single-recommendation success metric (SRSM)-based systems, provide recommendations based on increasing a success metric for a particular recommendation. That is, conventional recommendation systems may not consider the long-term consequences of its recommendations. Rather, a SRSM-based system may recommend a particular item based on an analysis attempting to optimize a current user-interaction without regard to future impact or consequences. In other words, such conventional systems employ short-term analysis.

In contrast to the short-term analysis of conventional systems, the enhanced recommendation technologies discussed herein do consider the long-term consequences of its recommendations. That is, the various embodiments described herein provide recommendations to repeat users that are based on optimizing, or at least increasing, a lifetime value (LTV) or a value for a cumulative-success metric (CSM), for the repeat user.

As discussed more fully below, conventional SRSM-based systems may result in reduced satisfaction among both the recommending party and the user that receives the recommendation. For instance, a merchant or vendor that provides a recommendation that is directed at increasing the success of the single recommendation may lose the opportunity to sell higher valued items to the user in the future, or even lose the user as a customer for future interactions, i.e., the merchant's LTV for that user is less than the embodiments herein might otherwise provide. Likewise, the user that receives such conventional recommendations may be less than satisfied with the recommendations and seek recommendations from another merchant or vendor, i.e., the user's satisfaction with the merchant may be less than the embodiments herein might otherwise provide. In contrast to conventional systems, the embodiments herein provide significant enhancements to the performance of a recommendation system based on the consideration of long-term consequences of item recommendations.

Furthermore, some conventional recommendation systems require manual determination and/or curation of user and item features, such as latent-features. For instance, current online marketplaces and e-commerce web sites may offer items numbering in hundreds of millions. Similarly, such marketplaces may serve hundreds of millions, or even billions, of users. The extreme labor and dimensionality of explicitly representing such numbers of users and items may adversely affect the usability and performance of such conventional systems. In addition to increasing future outcomes, and in contrast to conventional systems, the various embodiments herein provide performance enhancements due to the automatic determination of user and item latent-features via matrix factorization methods. Such matrix factorization methods may drastically reduce the dimensionality of the latent-feature spaces considered herein. Without such a reduction in dimensionality, conventional methods may prove practically intractable and/or not computationally feasible.

Online marketplaces, platforms, and websites may employ any of the various enhanced recommendation embodiments herein to provide item recommendations to its users. An item recommendation provided to a specific user is based on the specific user's item preferences, as well as the item preferences of each of the other users. Furthermore, each item recommendation is determined in such a way as to increase a cumulative value associated with multiple interactions with the specific user, i.e., the recommendation system provides item recommendations that optimize, or at least increase, the expected accumulation of reward signals across repeated future interactions with the specific user, rather than a single reward signal associated with a single or current interaction with the specific user.

More specifically, the embodiments generate and/or determine item-recommendation policies, based on user-item feedback interactions, and employ the determined item-recommendation policies to generate and/or determine future item recommendations. The determined item-recommendation policies are expected, from a stochastic point-of-view, to increase the value of a cumulative success metric associated with repeated interactions with the user, e.g., a lifetime value (LTV) or a value for a cumulative-success metric (CSM) associated with each user. In some embodiments, a cumulative success metric may be simply referred to as a cumulative metric. The value for the CSM is based on the accumulation of expected future reward signals, where the expected future reward signals are based on an item-recommendation policy.

Accordingly, the embodiments employ stochastic machine-learning (ML) methods to determine the item-recommendation policies that are stochastically expected to generate future reward signals that maximize, or at least increase, the value for the CSM. Such ML methods employ but are not limited to various embodiments of reinforcement learning (RL) methods, techniques, and processes. In the various embodiments, the RL methods employ the user-item data in Markov Decision Processes (MDPs). More succinctly, ML is employed to determine one or more item-recommendation policies that implement combinations of long-term and short-term recommendation strategies. The determined item-recommendation policies optimize, or at least increase, the accumulated success associated with multiple item recommendations provided to multiple repeat users.

In addition to employing ML to optimize the accumulated success associated with item recommendations, the various embodiments automate the determination of latent-features associated with each of the users, as well as latent-features associated with each of the available items. The user latent-features of a particular use may indicate the particular user's preference of the item latent-features of a particular item. Thus, the user latent-features of a user and the item latent-features of an item may be employed to generate a prediction of the user's preference for the item. The automatic determination of the user and item latent-features is based on the user-item data. In various embodiments, matrix factorization (MF) or matrix decomposition methods, techniques, or processes are employed to determine the user and item latent-features. As used throughout, user latent-features may be referred to as user features, and item latent-features may be referred to as item features.

Determining user latent-features and item latent-features significantly decreases the dimensionality of the search spaces considered by the ML methods. That is, each of the users and items may be represented by a vector, with a tractable dimensionality, that encodes the corresponding user's/item's latent-features. Thus, ML, such as but not limited to RL, may be tractably applied to the reduced-dimensionality spaces associated with the vectors representing the users and the items. More succinctly, the automatically determined user and item latent-features enable the efficient and tractable determination (i.e., learning) of the user's preferences for items that the user has not explicitly interacted with, i.e., when the user-item data does not include an associated user-item feedback event that explicitly couples the user and the item via the user's previously observed preference for the item.

Embodiments, systems, and methods that optimize, or at least increase, the expected value for a CSM for repeat users, such as but not limited to a LTV, may be referred to as CSM-based or CS-based embodiments, systems, and methods. Such CSM-based embodiments are contrasted with and provide numerous advantages over conventional systems that provide an item recommendation based on optimizing or increasing the expected return or value of a success metric associated with the current or single item recommendation. For instance, CSM-based embodiments consider the expected accumulated success of future repeated interactions with a user, rather than the expected success of only a single item recommendation (i.e., a single-recommendation success metric (SRSM)).

More particularly, CSM-based embodiments benefit from tradeoffs between long-term recommendation strategies for repeat users and the short-term recommendation strategies often associated with recommendation systems employing an SRSM, i.e., SRSM-based systems. As such, for a current recommendation, the embodiments herein may recommend items that are expected to result in a lower current reward signal via a single user-item feedback interaction, in lieu of other items that are expected to result in higher reward signals. However, the recommendation of the lower-yielding item may generate future user-item feedback interactions, associated with other items, that generate a significant accumulation of reward signals that is far greater than that associated with a corresponding SRSM-based system. Accordingly, CSM-based embodiments are enabled to receive the benefits associated with the tradeoffs between long-term and short-term recommendation strategies for repeat users, over the performance associated with short-term item strategies.

More specifically, CSM-based recommendation systems, such as those discussed herein, may expand a user's preferences, resulting in a large number of future high-yielding user-item feedback interactions. For instance, a CSM-based system may recommend a song that has a relatively low expected value for the success metric but is likely to expand the user's interest or preferences in various other songs, genres, artists, albums, or the like. The user's future selection and user-item feedback interactions associated with the expanded interest may result in a higher value for the CSM, as compared to recommending an alternative song that is expected to result in a relative high value for the success metric.

Furthermore, an SRSM-based system, by its nature, does not consider the long-term consequences of its recommendations. In service of maximizing the success of a current recommendation, SRSM-based systems may provide recommendations associated with a competitor or another such adverse party. In contrast, the embodiments herein consider the long-term consequences of each of the provided item recommendations, and do not divert user attention or loyalty due to such adverse item recommendations.

As yet another example of the benefits of the embodiments herein, in attempting to maximize a current interaction, an SRSM-based system may provide item recommendations in sequences that are detrimental to the user's interest. For instance, considering a trilogy of three sequential movies where the third or final movie is the most popular, an SRSM-based system may recommend the third movie prior to recommending the first movie. As the embodiments herein consider future consequences beyond the success of the current recommendation, such issues with erroneous ordering of sequential items is avoided.

Furthermore, although SRSM-based systems may generate relative success in single interactions, the generated item recommendations may not be sensitive to other considerations that may adversely affect the long-term consequences of such item-recommendations, i.e., reduce the future value of a CSM. For instance, SRSM-based systems may provide item recommendations that offend or do not account for the sensitivities of specific users, e.g., cultural sensitivities, health-related sensitivities, gender-related sensitivities, and the like. Again, as CSM-based systems consider long-term consequences; the various embodiments herein avoid such potentially offending item recommendations.

Accordingly, systems that attempt to optimize a current user-interaction without considering future impacts or consequences (i.e., SRSM-based systems) may result in future financial losses, or at least financial gains that are not as large as those accomplished via the various embodiments herein. In contrast, CSM-based embodiments provide significant enhancements to the performance of a recommendation system based on the consideration of long-term consequences of item recommendations.

In addition to increasing future outcomes, the various embodiments provide performance enhancements due to the automatic determination of user and item latent-features via MF methods. For instance, current online marketplaces and e-commerce websites may offer items numbering in hundreds of millions. Similarly, such marketplaces may serve hundreds of millions, or even billions, of users. The extreme dimensionality of explicitly representing such numbers of users and items as states within an RL framework, such as but not limited to an MDP, renders the search for an optimal item-recommendation policy intractable.

However, representing the users and items as combinations of a finite number of latent-features renders such RL methods tractable. For instance, in at least one embodiment, the users and items may be represented in spaces spanning hundreds or thousands of latent-features, resulting in many orders of magnitude of reduction in the dimensionality of spaces employed by the RL methods.

Furthermore, the various embodiments automatically determine the latent-feature representations of the users and the items. That is, the latent-features are not manually determined, provided, and/or tuned. Such manual determination of latent-features may suffer from the introduction of non-optimized or even irrelevant features. For instance, manually provided features may include non-relevant features, trivial features, redundant features, or features that do not appropriately scale with increasing volumes of user-item data.

Additionally, manually provided and/or tuned features may include separate data types, and thus, may not be easily combinable within an RL framework. For instance, some manually determined features may be a binary data type (e.g., gender), while other such manually determined features may include integer data types (e.g., the number of interactions) or floating point data types (e.g., rate of success). Combining different data types within a single vector representation may increase difficulties in applying the various RL methods.

Other manually determined features may have little relevancy in the representation of the users and items for the purpose of determining the user's item preferences. That is, user features that are typically manually provided and/or determined, such as the operating system of the user, time zone, and/or geo-location, may provide little insight into the user's item preferences. Also, manually determined features may be static and do not consider dynamic qualities of the state of the users and items.

In contrast, the various embodiments herein automatically determine the most relevant latent-features for representing the users and items in a space of reduced-dimensionality with the goal of determining the user's item preferences. Accordingly, the various embodiments herein do not suffer from such deficiencies.

Furthermore, the user-data employed to determine user and item latent-features, as well as determine the optimized item-recommendation policies is continually updated as users continue to interact with the recommendation systems. That is, as users continue to provide additional user-item feedback interactions, the user-item data is updated to include the corresponding additional user-item feedback events. The user and item latent-feature representations can be updated and employed to further update the item-recommendation policies. Such updating of the user and item latent-features and the item-recommendation policies provides a dynamically-enhanced recommendation system that adapts and evolves based on the user's current preferences and the introduction to newly available items.

Additionally, as discussed above, the various embodiments provide a workflow that automatically demonstrates the improvement of a CSM determined item-recommendation policy over an item-recommendation policy currently deployed in a “live” online e-commerce website. Such workflows are enabled to demonstrate and quantify such improvements, prior to the CSM-based item-recommendation policy being deployed in the “live” website. Accordingly, the various embodiments provide assurances that a substitution, within a “live” website, of the current item-recommendation policy for an item-recommendation policy determined via the various embodiments herein will not result in adverse consequences, i.e., financial losses, decreases in the credibility and/or reputation of a party deploying the various systems and/or methods discussed herein, or negatively affecting the user's perceptions of the effectiveness and/or appropriateness of the system's item recommendations.

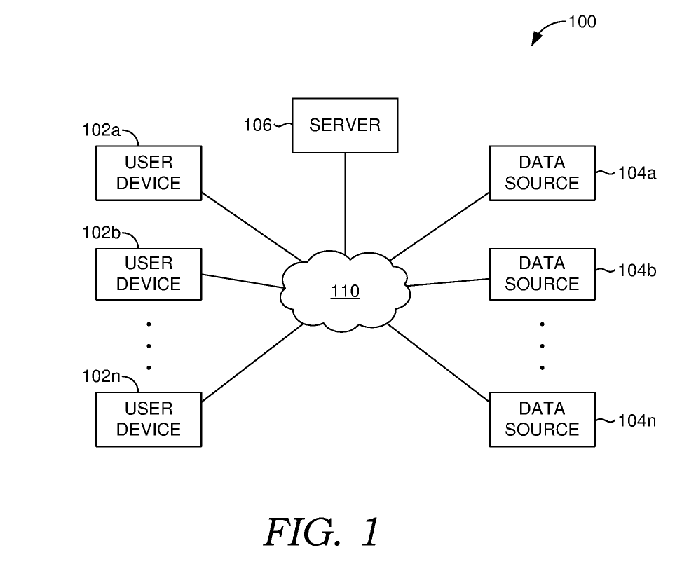

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

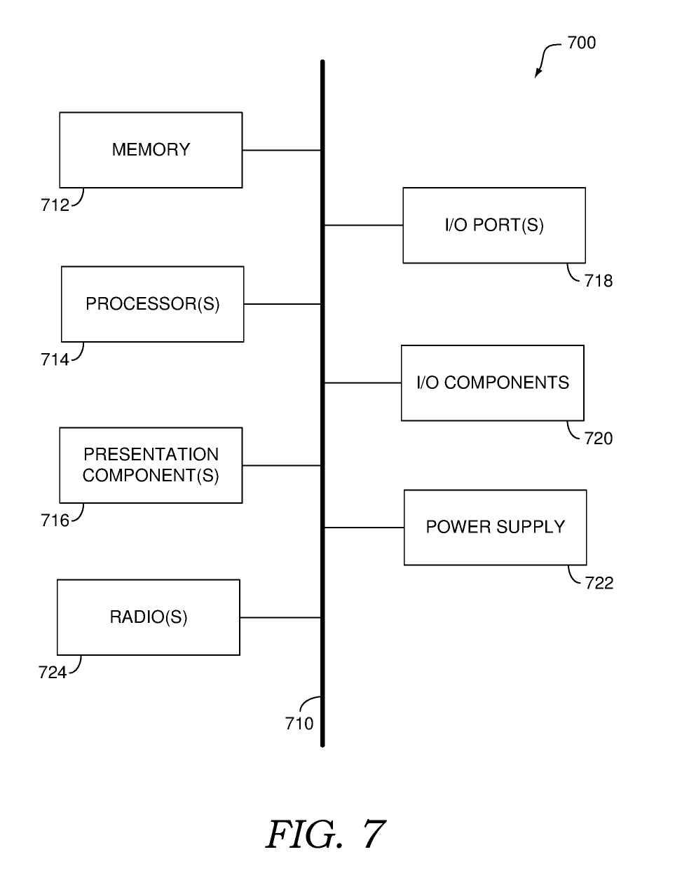

Among other components not shown, example operating environment 100 includes a number of user devices, such as user devices 102a and 102b through 102n; a number of data sources, such as data sources 104a and 104b through 104n; server 106; and network 110. It should be understood that environment 100 shown in FIG. 1 is an example of one suitable operating environment. Each of the components shown in FIG. 1 may be implemented via any type of computing device, such as computing device 700 described in connection to FIG. 7, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 7 herein. By way of example and not limitation, a user device may be embodied as a personal computer (PC), a laptop computer, a mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, or any combination of these delineated devices, or any other suitable computer device.

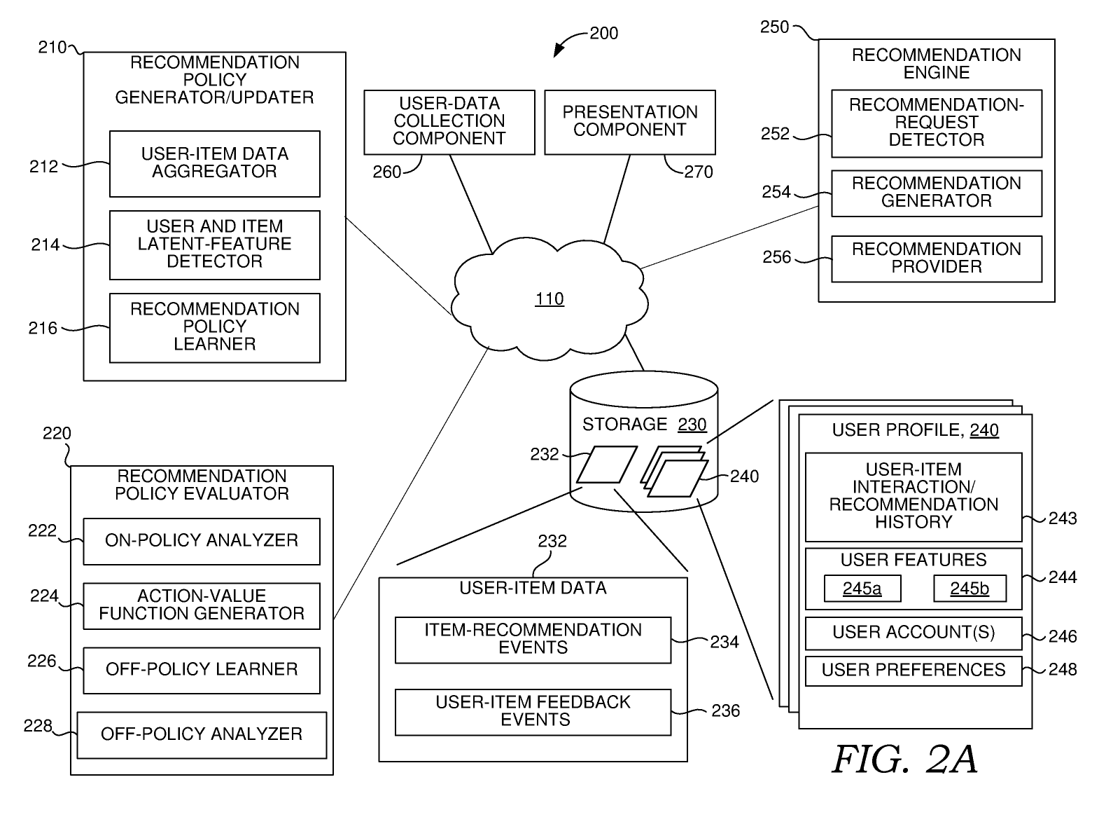

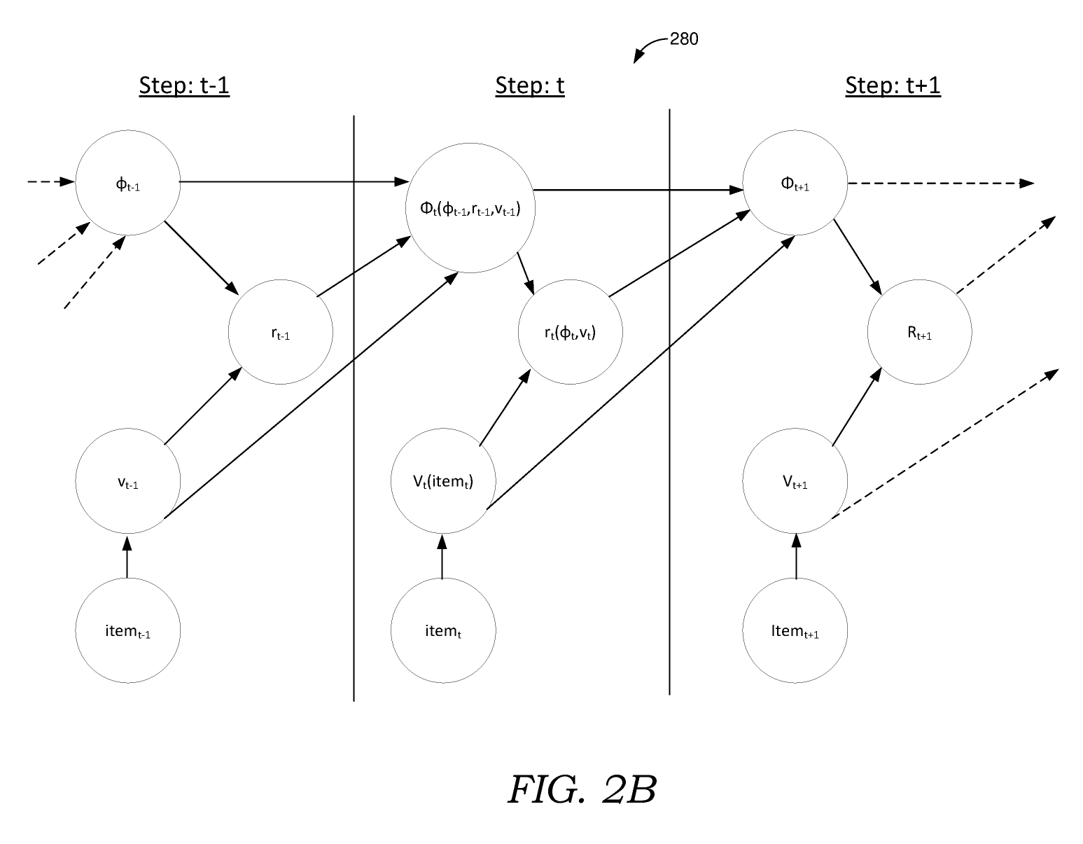

Data sources 104a and 104b through 104n may comprise data sources and/or data systems, which are configured to make data available to any of the various constituents of operating environment 100, or system 200 described in connection to FIG. 2A. (For instance, in one embodiment, one or more data sources 104a through 104n provide (or make available for accessing) user data to user-data collection component 260 of FIG. 2A.) Data sources 104a and 104b through 104n may be discrete from user devices 102a and 102b through 102n and server 106 or may be incorporated and/or integrated into at least one of those components.

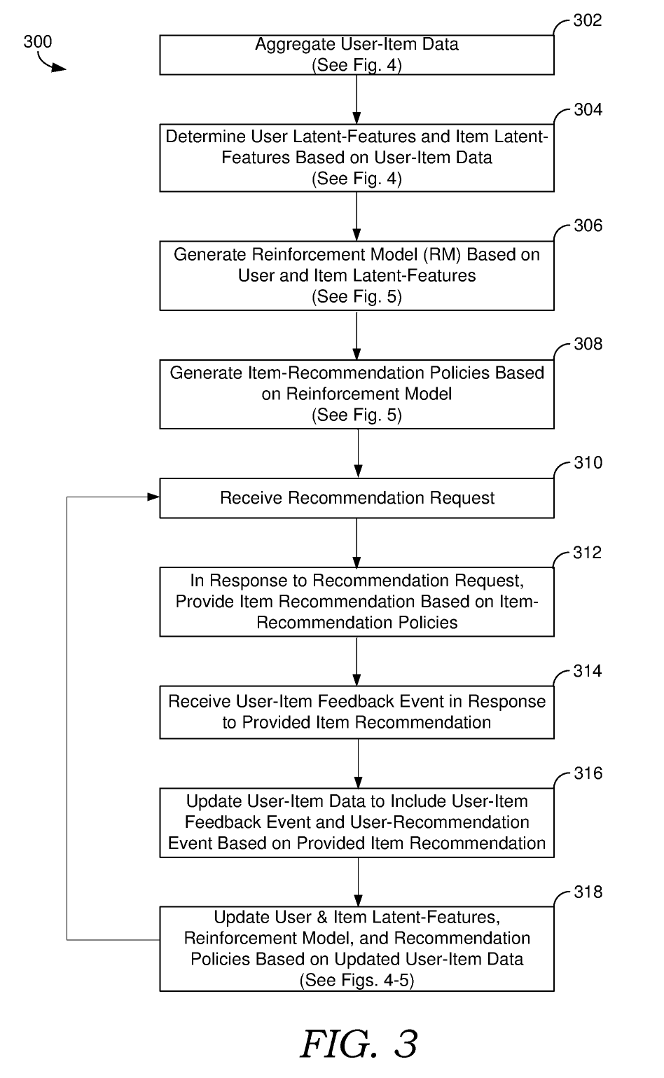

Operating environment 100 can be utilized to implement one or more of the cumulative success-based systems 200, described in FIG. 2A, including components for generating/updating item-recommendation policies, evaluating item-recommendation policies, and providing item-recommendations based on the item-recommendation policies, and/or generating user profile details. Operating environment 100 also can be utilized for implementing aspects of process flows 300-600, described in conjunction with FIGS. 3-6.

Referring now to FIG. 2A, with FIG. 1, a block diagram is provided showing aspects of an example computing system architecture suitable for implementing an embodiment of the disclosure and designated generally as cumulative success-based recommendation system 200 (i.e., a CS-based or a CSM-based system). The CS-based recommendation system 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

The CS-based recommendation system 200 includes network 110, which is described in connection to FIG. 1, and which communicatively couples components of CS-based recommendation system 200, including user-data collection component 260, presentation component 270, user profile 240 (through storage 230), recommendation engine 250, recommendation policy generator/updater 210, and recommendation policy evaluator 220. As described herein, user features in user profile 240 are generated based on different user signals, such as user features 244, user account(s) 246, user preferences 248, and the like. As discussed throughout, user features 244 may include various automatically determined user features 245a and/or manually provided user features 245b. Additionally, signals from recommendation policy generator/updater 210, recommendation policy evaluator 220, recommendation engine 250, and additional user signals may be combined together to generate combined insights or features. A user history, such as those discussed below may be stored in user-item interaction/recommendation history 243. The components of CS-based recommendation system 200 may be embodied as a set of compiled computer instructions or functions, program modules, computer software services, or an arrangement of processes carried out on one or more computer systems.

It should be understood that the CS-based recommendation system 200 shown in FIG. 2A is an example of one system in which embodiments of the present disclosure may be employed. Each component shown may include one or more computing devices similar to the computing device 100 described with reference to FIG. 1. The CS-based recommendation system 200 should not be interpreted as having any dependency or requirement related to any single module/component or combination of modules/components illustrated therein. Each may comprise a single device or multiple devices cooperating in a distributed environment. For instance, the CS-based recommendation system 200 may comprise multiple devices arranged in a distributed environment that collectively provide the functionality described herein. Additionally, other components not shown may also be included within the network environment. It should be understood that the CS-based recommendation system 200 and/or its various components may be located anywhere in accordance with various embodiments.

The CS-based recommendation system 200 generally operates to provide a user device (such as user device 102a of FIG. 1, for example) one or more item recommendations. The system 200 gathers, organizes, and analyzes data including user-item data 232 to provide the item recommendation. The system 200 thus is able to: determine user latent-features for a plurality of users, determine item latent-features for a plurality of available items, determine one or more item-recommendation policies based on the latent-features, and provide item recommendations to each of the plurality of users based on the recommendation policies and the user-item data, allowing for a variety of downstream uses.

User-data collection component 260 is generally responsible for accessing or receiving (and in some cases also identifying) user-item data and user data from one or more data sources, such as data sources 104a and 104b through 104n of FIG. 1. In some embodiments, user-data collection component 260 may be employed to facilitate the accumulation of user-item feedback events 236 and item-recommendation events 234 for all users of the CS-based recommendation system 200. Such data may be received (or accessed), and optionally accumulated, reformatted, and/or combined, by user-data collection component 260 and stored in one or more data stores such as storage 230, where it may be available to other components of the CS-based recommendation system 200. Further, the user-data collection component 260 may be configured to associate each of the user-item feedback events 236 and each of the item-recommendation events 234 with one or more user profiles and to store the associated user-item feedback and item-recommendation events in a corresponding user profile 240.

Example system 200 also includes storage 230. Storage 230 generally stores information including data, computer instructions (e.g., software program instructions, routines, or services), and/or models used in embodiments of the technologies described herein. In an embodiment, storage 230 comprises a data store (or computer data memory). Further, although depicted as a single data store component, storage 230 may be embodied as one or more data stores or may be in the cloud.

User-item data, such as but not limited to item-recommendation events 234 and user-item feedback events 236 may be received from a variety of sources where the data may be available in a variety of formats. For example, in some embodiments, user-item data are received via user-data collection component 260 may be determined and/or received from one or more user devices (such as user device 102a), servers (such as server 106), and/or other computing devices.

Recommendation policy generator/updater 210 is generally responsible for generating (or determining) and updating one or more item-recommendation policies based on aggregated user-item data. Recommendation policy evaluator 220 is generally responsible for evaluating the cumulative success of a determined item-recommendation policy, in comparison to other item-recommendation policies, such as those that were used to generate the user-item data. That is to say, recommendation policy evaluator 220 enables a workflow to evaluate a cumulative success of a current item-recommendation policy, and evaluate the performance of the updated item-recommendation policy (such as one generated via recommendation policy generator/updater 210), as compared to the current item-recommendation policy, prior to deploying the updated item-recommendation policy in an online “live” e-commerce system. Recommendation engine 250 is generally responsible for employing the determined item-recommendation policies to generate/determine and provide item-recommendations to the users of system 200.

In some embodiments, recommendation policy generator/updater 210 may include a user-item data aggregator 212, a user and item latent-feature detector 214, and a recommendation policy learner 216. User-item data aggregator 212 may be generally responsible for aggregating the user-item data, including at least user-item feedback events 236 and item-recommendation events 234. User and item latent-feature detector 214 may be generally responsible for determining, identifying, and/or detect the latent-features associated with each of the users of system 200 and available items (i.e., the user latent-features and the item latent-features). In at least one embodiment, user and item latent-feature detectors employ matrix factorization (MF) or matrix decomposition methods to determine the user and item latent-features. Recommendation policy learner 216 is generally responsible for generating a reinforcement model (RM) based on the user and item latent-features, as well as generating and/or determining one or more item-recommendation policies based on the RM. In some embodiments, the RM model is generated via reinforcement learning (RL) or other such machine learning (ML) methods.

As additional user-item data is acquired, recommendation policy generator/updater 210 may aggregate the newly acquired user-item data with the previously acquired user-item data. Furthermore, recommendation policy generator/updater 210 may update the user and item latent-features based on the newly acquired user-item data and update the RM based on the updated user and item latent-features. Furthermore, recommendation policy generator/updater 210 may update the item-recommendation policies based on the updated RM.

In at least some embodiments, recommendation engine 250 includes a recommendation-request detector 252, a recommendation generator 254, and a recommendation provider 256. The recommendation-request detector 252 is generally responsible for receiving, detecting, and/or identifying a request for one or more item recommendations. For instance, recommendation-request detector 252 may receive a recommendation request from a server device, such as but not limited to server 106 of FIG. 1 or a user device, such as but not limited to user device 102a of FIG. 1. Recommendation generator 254 is generally responsible for generating an item recommendation, based on the item-recommendation policies, and in response to the received item recommendation request. That is to say, recommendation generator 254 generally employs the item-recommendation policies generated (and updated) via recommendation policy generator/updater 210. Recommendation provider 256 is generally responsible for providing the generated item recommendation to the requester. For instance, recommendation provider 256 provides the item recommendation to the recommendation requester, e.g., server 106, user device 102a, or the like.

In at least some embodiments, recommendation policy evaluator 220 evaluates an item-recommendation policy (provided via recommendation policy generator/updater 210) prior to the item-recommendation policy being deployed in recommendation engine 250. As such, recommendation policy evaluator 220 may include an on-policy analyzer 222, an action-value function generator 224, and off-policy learner 226, and an off-policy analyzer 228.

On-policy analyzer 222 is generally responsible for determining a value of one or more current item-recommendation policies. For instance, on-policy analyzer 222 determines an estimation of the cumulative-success value for the current item-recommendation policies. That is, on-policy analyzer 222 evaluates the “behavior policy” that may have been employed to at least partially generate the user-item data. Action-value function generator 224 is generally responsible for generating and/or determining the action-value function of the current item-recommendation policy, i.e., the behavior policy. Off-policy learner 226 is generally responsible for determining and/or generating an updated item-recommendation policy, i.e., the “target policy,” based on the action-value function. For instance, off-policy learner 226 performs “off-policy” learning to optimize the action-value function and determine a target policy that provides an improvement over the behavior policy. In various embodiments, off-policy learner 226 may employ at least some of the functionalities and/or components of recommendation policy generator/updater 210. Off-policy analyzer 228 is generally responsible for evaluating the updated item-recommendation policies (i.e., the target policy) based on a comparison with the evaluation of the behavior policy.

Returning attention to recommendation policy generator/updater 210, user-item data aggregator 212 is enabled to aggregate user-item data, where aggregating user-item data includes at least aggregating multiple user-item feedback events and item-recommendation events associated with multiple users and associated with multiple items. Aggregating user-item data may include generating and/or determining the correspondence, correlation, and/or association between item-recommendation events and the resulting user-item feedback events. The association may be a one-to-one association. Aggregating user-item data may also include temporally ordering and indexing the item-recommendation events and associated user-item feedback events into sequential steps. For instance, an initial item-recommendation event (and associated user-item feedback event) may be indexed via t=0, wherein a temporally next item-recommendation event (and associated user-item feedback event) may be indexed via t=1, where t=0, 1, 2, . . . p−1 and p is the total number of available item-recommendation events and associated user-item feedback events.

Aggregating user-item data may also include generating a user-item matrix based on the aggregated user-item feedback events. In the various embodiments, there are m users and n items, where each of m and n are positive integers. There are virtually no upper limits to the specific values of m and n. For instance, in various embodiments, m, n˜10⁷-10¹⁰. Aggregating user-item feedback events may include generating an n-dimensional vector for each of the m users. Such an n-dimensional vector may be referred to as a “user-item vector,” because, as discussed below, the components of the i-th vector (where i=1, 2, 3, . . . , m) couple the i-th user to each of the n items, via reward signals previously provided by the i-th user. More particularly, the j-th component (where j=1, 2, 3, . . . , n) of the i-th vector may include the reward signal (i.e., the i-th user's preference value for the j-th item) of a user-item feedback event associated with the i-th user and the j-th item.

Thus, i may be an integer index that uniquely identifies a user and j is an integer index that uniquely identifies an item. Accordingly, the User_ID of a user-item feedback event may be the integer index i and the Item_ID of the user-item feedback event is the integer index j. Other embodiments may employ a one-to-one mapping between i and User_ID and another one-to-one mapping between j and Item_ID. In the various embodiments, aggregating user-item data may include generating m user-item vectors, each with dimensionality of n.

In the scenario, where the i-th user has provided multiple user-item feedback interactions associated with the j-th item, the j-th component may include a combination of the multiple reward signals, e.g., an arithmetic or geometric sum, a mean, median, or other moment of a distribution of the reward signals, or the like. When no user-item feedback event is available that is associated with both the i-th user and the j-th item (i.e., when the user has not previously expressed a preference for the event), then the component may be set to a default value, such as but not equal to 0.0, or alternatively, an average reward signal determined over all the users. For instance, for the i-th user-item vector, the j-th component may be set to 1 when the i-th user has previously accepted the j-th item, and set to 0.0 when the i-th user has previously rejected the j-th item or has not interacted with the j-th item. Note that the components of the user-item vectors need not be binary components, but can take on any value-types (such as a real or an integer number) of the reward signals, either singly or in combination. To generate the above mentioned user-item matrix ( [symbol] ), the m (n-dimensional) user-item vectors may be arranged as the rows of a (n×m) matrix, i.e., [symbol] ∈ [symbol] ^{m,n}.

In the various embodiments, user and item latent-feature detector 214 determines, identifies, and/or detects the user and item latent-features via a decomposition and/or factorization of the user-item matrix, i.e., matrix factorization (MF) is employed to the determine the factors of the user-item matrix. To determine the user and item latent-features, user and item latent-feature detector 214 may further generate user vectors and item vectors based on a user matrix and an item matrix, i.e., the factors of the user-item matrix. A user vector may be encoded in a user data structure (DS). Similarly, an item vector may be encoded in an item DS. Thus, determining user and item latent-features may include generating user and item vectors and/or generating user and item DSs that encode the vectors. That is, generating user DSs that encode the user latent-features for each user and generating item DSs that encode the item latent-features for each item.

More specifically, the users and items may be decoupled via the determination of a user matrix (U) and an item matrix (V) such that UV= [symbol] . A dimensionality (k) of the user and item latent-feature space may be determined (or chosen), where k<m, n. Thus, U∈ [symbol] ^{m,k}, V∈ [symbol] ^{k,n}. In some embodiments, k<<m and k<<n. For instance, k˜10²-10³ in various embodiments.

Virtually any MF or matrix decomposition method or technique may be employed to determine each of U and V. For instance, U and V may be iteratively determined via minimizing the squared difference between observed samples and current estimates for U and V via stochastic descent or alternating least squares. To reduce over-fitting issues, regularization and bias terms may be incorporated when minimizing the squared differences. Other techniques may be employed to determine the factors of the user-item matrix. Such other techniques include, but are not limited to Bayesian Personalized Recommendation, Probabilistic Matrix Factorization, and Poisson Factorization.

Each of the m columns of U represents the user latent-features for a particular user, i.e., the components of i-th column of U correspond to each of the k latent-features of the i-th user. Thus, once the factors of the user-item matrix are determined, a user vector for the i-th user (i.e., a vector representing the i-th user in the k-dimensional user latent-feature space) may be generated based on the components of the i-th column of U. The i-th user vector may be referenced as uᵢ, where uᵢ∈ [symbol] ^{k}.

Similarly, each of the n rows of V represents the item latent-features for a particular item, i.e., the components of the j-th row of V correspond to each of the k latent-features of the j-th item. Thus, an item vector for the j-th item (i.e., a vector representing the j-th item in the k-dimensional item latent-feature space) may be generated based on the components of the j-th row of V. The j-th item vector may be referenced as vⱼ, where v∈ [symbol] ^{k}.

Recommendation policy learner 216 implements a reinforcement learning (RL) framework to generate a reinforcement model (RM) to learn, plan, generate, and or determined the item-recommendation policy based on the user and item latent-features, as well as user-item data. The recommendation policy learner 216 employs a Markov Decision Process (MDP) framework to model the sequential interactions (i.e., time-ordered trajectories) between a DSM-based recommendation system and a stochastic environment (the users and the users' response to provided item recommendations).

Generally, the RM is represented and/or encoded via an n-tuple: RM=(S, A, P, R, v). S is the state space, A is the action space, P is a transition probability kernel, R is the reward function, and v is the initial state distribution. The RM considers an artificial intelligence (AI) agent sequentially performing actions (included in A), that result in stochastic transitions through S, as regulated via P, where each transition results in an award within R. The sequential actions (and locations in S) are indexed via a time index, t=0, 1, 2, . . . . The above n-tuple may be a decision-process data structure (DS). Thus, the RM may include a decision-process DS. As noted above, in some embodiments, the decision process is a MDP, thus the n-tuple may be a MDP DS.

More particularly, an initial state (s₀˜v) is sampled from S, where the subscript refers to the time index. At each time set, the agent stochastically determines an action (aₜ∈A) based on a policy (π(aₜ|sₜ)). The agent receives a reward (rₜ˜R(sₜ, aₜ)) and the t-th state (sₜ) stochastically transitions to the next state (sₜ₊₁) via (sₜ₊₁˜P(sₜ, aₜ)). Note that the reward is determined probabilistically based on taking action (aₜ), from state (sₜ). Thus, the reward may be a stochastic reward. The policy is essentially conditionally probability transition that provides the agent a statistical likelihood (π(aₜ|sₜ)) for choosing action (aₜ), given the agent's current state (sₜ). Thus, because the agent is making a choice regarding which action to undertake, where the expected outcome (i.e., the state transition) can only stochastically evaluated, an MDP framework may be employed.

An agent's performance may be determined based on a cumulative success metric (CSM), i.e. a metric that is evaluated based on an accumulation of the received reward signals over multiple transitions or time-steps. In general, after a number of steps, the larger the value of the agent's CSM, the greater accumulation of rewards that agent has received due to the choices for actions. Thus, employing a policy the increases the expected value for a CSM improves the agent's performance.

In general, an expected cumulative reward (as a function of the initial state and based on a given policy) may be determined as: V^{π}(s)= [symbol] _{π}[Σₜ₌₀^{∞}γ^{t}rₜ|s₀=s], where (γ∈(0,1]) is a forgetting factor (or discount parameter) such that rewards from the distant past (or future) may be effectively neglected or at least discounted. Note that for γ>0, the accumulation of the rewards is reduced, i.e., rewards are reduced based on the temporal difference (as indicated by the t index), i.e., how far in the future are the rewards. The mean of the expected cumulative reward (evaluated over the distribution of initial states) may be determined as: J^{π}=Σ_{s∈s}v(s)V^{π}(s). Thus, in some embodiments, the expected cumulative rewards may be a CSM. Note that such CSMs, or simply cumulative metrics, include an expected value for an accumulation of stochastic user-item rewards associated with subsequent item recommendation.

In the various embodiments, recommendation policy learner 216 employs the user and item latent-features (encoded within the user and item vectors) to determine item recommendation policies (it) that increase the value of a CSM, such as but not limited to J^{π}. Evaluating a CMS based on a specific item-recommendation policy is further based on the expected value for reward signals provided in response to future item recommendations that are determined via the specific item-recommendation policy.

To determine an item-recommendation policy that maximizes, or at least increases, a CSM, an “off-policy” analysis of the aggregated user-item data may be performed via RL. That is, recommendation policy learner 216 may determine an item-recommendation policy that is expected to increase a CSM associated with future item recommendations and associated user-item interactions based on previously acquired temporally sequenced item-recommendation events and associated user-item feedback events. More particularly, the various embodiments generate an RM by determining the state space and action space of the RM based on the user-item data. For each user, the user-item data is employed to generate temporally ordered sequences of steps (i.e., trajectories) through the action space of the RM and trajectories through the reward space of the (R) of the RM. Such action trajectories and reward trajectories are employed to generate a user history for each user. The user history for a particular user is employed to determine a trajectory through the state space for the particular user. Such trajectories are employed to generate and/or determine an item-recommendation policy that increases a CSM that may be generated based on the RM.

FIG. 2B provides a graphical representation 280 of trajectories within a reinforcement model (RM) that is consistent with various embodiments described herein. In particular, FIG. 2B graphically demonstrates a process that may be employed by the various embodiments to generate an RM and item-recommendation policies based on the user-item data. Graphical representation shows three temporally ordered (i.e., a sequence of) steps for a particular user (based on user-item data associated with the particular user). The temporally ordered steps are labeled by the sequence of integer indices t−1, t, t+1. At each temporal step, the n-tuple of the RM includes at least a position within the state space (S) of the RM, a position (or at least a reward signal scalar-value) within the reward space (R) of the RM, and a position within the actions space (A) of the RM. For a particular user, trajectories within these spaces include temporally ordered sequences of positions with the spaces. FIG. 2B shows such trajectories for the i-th user, where the positions of the trajectories are represented via nodes (or vertices) of a directed graph. The directed edges of the graph demonstrate the dependency of the determination of each node on the other nodes. The dependencies are explicitly indicated in functional notation in the t step.

More specifically, for a particular user, temporally-ordered sequences of positions (i.e., trajectories) through the action space (A) of the RM (i.e., action trajectories) are modeled based on the sequence of item recommendations provided to the particular user (i.e., temporally ordered item-recommendation events). Thus, action trajectories are encoded in a sequence (i.e., an ordered set) of item vectors corresponding to the sequence of items recommended to the particular user. Within the action space, each recommended item may be represented by the item vector for that item. Because the item vectors are within the action space, item vectors may be referred to throughout as “action vectors.” Representing each of the recommended items via the item latent-features significantly reduces the dimensionality of the action space. Thus, in the various embodiments, the action space may be spanned via a set of vectors with dimensionality k, where k is the number of item latent-features.

For instance, as shown in FIG. 2B, for itemₜ (where itemₜ is an index that references the item that was recommended at t), the corresponding position within the action space may be represented by the corresponding item vector vₜ. Thus, an action trajectory for i-th user may be represented by a sequence of item vectors: v_{i,0}, v_{i,1}, v_{i,2}, . . . , v_{i,Ti}, where Ti+1 is the number of item-recommendation events (with associated user-item feedback events) for the i-th user. Thus, for a particular user, action trajectory is thus based on a sequence of item recommendations previously provided to the particularly user.

For a particular user, trajectories through the reward space (R) of the RM (i.e., reward trajectories) are modeled based on the sequence of reward signals the particular user provided in response to the provided item recommendations (i.e., the associated user-item feedback events), where the reward signals may be expressly encoded in the sequence in the associated sequences of user-item feedback events. As shown in FIG. 2B, a reward trajectory for the i-th user may be represented by the sequence of scalar values: r_{i,0},r_{i,1},r_{i,2}, . . . , r_{Ti}. Note that the value of the reward signal (rₜ) represents a stochastic reward resulted from choosing action (vₜ), while in position (φₜ) within the state space (S).

For the particular user, trajectories through the state space (S) of the RM may not be directly observable via the user-item data, at least because the state space is based on some “inner” state of the particular user. However, the state trajectory for a user may be generated from latent-features encoded within the user's history of being recommend items and providing user-item feedback interactions based on the provided item recommendations concatenated and/or combined with the associated user-item reward, i.e., a user history. For each user, a user history may be generated based on a concatenation and/or combination of the user's action trajectory and the user's reward trajectory. For instance, the user history (at step t) for the i-th user may be represented as: h_{i,t}=(v_{i,1},r_{i,1})ₗ₌₀^{t}. Thus, a user history may be a matrix that includes concatenations of item vectors and rewards. The matrix may be encoded in various data structures (DSs).

The latent-features (φ(s_{i,t})∈ [symbol] ^{k}) of the state (s) at step t for the i-th user may be determined from the user history at step t via matrix factorization (MF) as discussed throughout. That is, the state trajectory for the i-th user may be generated from an ordered sequence of state vectors (e.g., time-dependent user vectors based on time dependent user later-features), where: u_{i,t}=φ(s_{i,t})=MF(h_{i,t}). Thus, the RM model may include the three trajectories: state trajectory, action trajectory, and reward trajectory for each user. The three trajectories for the m users may be represented via:

$$RM = {\{ {( ϕ ( {s}_{i , t} ) , {v}_{i , t} , {r}_{i , t} )}_{t = 0}^{Ti} \}}_{i = 1}^{m} .$$

Note that a linear function approximation of expected cumulative reward may be evaluated via: V(s)≈θ^{T}φ(s), where θ∈ [symbol] ^{k} is a cumulative-success weighting vector.

Any method, process, or technique, such as but not limited to a reinforcement learning (RL) method, that increases a CSM (based on the accumulation of reward signals r), such as but not limited to J^{π}, may be applied to generate and/or determine an item-recommendation policy (π(v|φ(s))).

Although specific embodiments for determining item-recommendation policies are discussed above, other embodiments are not so constrained. Any method that determines the user and item vectors (based on latent-features) to model the trajectories encoded in the user-item data may be employed to determine an item-recommendation policy. For instance, recurrent neural networks (RNN) may be applied to determine the item-recommendation policies based on the trajectories.

Returning attention to FIG. 2B, recommendation policy evaluator 220 is generally responsible for evaluating the cumulative success of a determined item-recommendation policy, in comparison to other item-recommendation policies, such as those that were used to generate the user-item data. On-policy analyzer 222 determines an estimation of the cumulative-success value the for the current item-recommendation policies. That is, on-line policy analyzer 222 analyzes the item-recommendation policies that were employed to recommend the items to the users for the generation of the user-item interaction events. In various embodiments, the item-recommendation policy that was deployed for the acquisition of the user-item data may be referred to as the “behavior policy.” Thus, determining an estimation of the cumulative success of the behavior policy may include an evaluation and/or analysis of the user-item data, similar to that discussed in the above embodiments.

Action-value function generator 224 is generally responsible for generating and/or determining the action-value function of the current item-recommendation policy. The action-value function (Q^{π}(s,a)) may be employed to determine the cumulative expected value of first taking an action (a) from initial state (s), and then following policy π for the remaining steps within the RM, i.e., Q^{π}(s,a)= [symbol] [R((s,a))]+γΣ_{s′∈S}P(s′|s,a)V^{π}(s′). Thus, the action-value function may be employed to make a one-step improvement over a current policy by maximizing its value over the actions included in the user-data. Due to the preceding notation, in some embodiments, the action-value function may be referred to as the Q-function. Similar to the expected cumulative rewards (i.e., V^{π}(s)), a linear function approximation of the action-value function may be evaluated via: Q (s,a)=θ^{T} φ(s,a), where θ∈ [symbol] ^{k} is a cumulative-success weighting vector and φ(s,a) is a vector encoding the latent-features for the state-action pair comprising s and a. Thus, the various embodiments employ a latent-feature vector for each state-action pair. As noted throughout, the determination of such state-action latent-feature vectors (for state-action pairs) may be automated via combining and/or concatenating the state latent-feature vectors (φ(s)) and the item latent-feature vectors (i.e., the item vectors).

Off-policy learner 226 is generally responsible for determining and/or generating an updated item-recommendation policy, i.e., a “target policy,” based on the action-value function. That is, off-policy learner 226 performs “off-policy” learning to optimize the action-value function and determine an updated item-recommendation policy that provides an improvement over the current item-recommendation policy. Off-policy analyzer 228 evaluates the updated item-recommendation policies based on a comparison between the current item-recommendation policy and the updated item-recommendation policy.

In the various embodiments, determining a cumulative success of the current item-recommendation policy (i.e., the behavior policy) includes determining a current cumulative-success weighting vector, (θ_{b}) such that V^{π}^{_{b}}(s)≈θ_{π}_{_{b}}^{T}φ(s), based on the trajectories determined via the user-data, where the b subscript refers to the behavior (or current) policy. The current cumulative-success weighting vector may be determined based on various least-squares methods, such as but not limited to least squares temporal difference (LSTD) methods. The CSM, such as but not limited to J^{π}^{_{b}}, may be determined based on the current cumulative-success weighting vector via sampling states of the trajectories and averaging over the sampled values. In other embodiments, Monte Carlo simulations may be employed to determine the CSM of the behavior policy.

The action-value function may be determined and/or generated based on the cumulative-success weighting vector and the state-action latent-feature vectors, e.g., Q(s,a)=θ_{Q}^{T}φ(s,a), where θ_{Q} is current cumulative-success weighting vector. The state-action latent-feature vectors may be determined based on the state latent-feature vectors (φ(s)) and the item latent-feature vectors (i.e., the item vectors (v)). An additional constant feature may additionally be concatenated with the concatenation of φ(s) and v. The state latent-feature vectors and the item vectors may be determined, as discussed in conjunction with the various embodiments, when determining the cumulative p of the behavior policy. Note that the coordinate-wise product (i.e., the Hadamard product: [φ(s)⊙v)]ᵢ=[φ(s)]ᵢ·[v]ᵢ) of state latent-feature vector and the item vector is associated with the success probability and may be additionally concatenated with above vectors to generate state-action latent-feature vectors. Thus, in one non-limiting embodiment, a state-action latent-feature vector for state-action pair (s,a) is generated based on a coordinate-wise product of these vectors, such as φ(s,a)=(φ(s), v, φ(s)⊙v,1).

Once the state-action latent-feature vectors are determined, various LSTD methods may be employed to determine the current cumulative-success weighting vector (θ_{Q}) based on the state-action latent-feature vectors such that Q (s,a)=θ_{Q}^{T}φ(s,a).

Once the action-value function has been determined via the determination of the state-action latent-feature vectors and the current cumulative-success weighting vector, the updated item-recommendation policy may be determined based on the action-value function. That is, the action-value function may be optimized such that the updated item-recommendation policy provides an improvement over the current item-recommendation policy, i.e., an updated item-recommendation policy is chosen to increase an evaluation of the action-value function. In various embodiments, the updated item-recommendation policy may be referred to as the “target policy.” As noted above, the current item-recommendation policy may be referred to as the behavior policy.

In various embodiments, an item-recommendation policy may be represented via a parameterization. For instance, an item-recommendation policy may be represented in parameterized form as (neglecting normalization): π(v|s)∝exp(w_{π}^{T}φ(s,a)), where w_{π} is policy weighting vector that parameterizes the policy π. Thus, in various embodiments, determining and/or generating an item-recommendation policy may include determining the policy weighting vector that maximizes (or at least increases) the associated CSM. Note that once the policy weighting vector is determined, the parameterized form may be normalized prior to the deployment of the parameterized item-recommendation policy.

For the behavior policy, w_{π}_{_{B}} may be determined (e.g., learned via the user-item data). For the updated item-recommendation policy (i.e., the target policy) an updated policy weighting vector (w_{π}_{_{T}}) may be determined that increases the CSM, as compared to W_{π}_{_{B}}. One such non-limiting updated policy weighting vector is: W_{π}_{_{T}}=αθ_{Q}, where α>0.

To evaluate the updated item-recommendation policy, a comparison between the updated item-recommendation policy and the current item-recommendation policy may be generated. For instance, an evaluation of a CSM based on an item-recommendation policy parameterized via W_{π}_{_{B}} (e.g., the cumulative-success value determined in block 602) may be compared to an evaluation of the CSM based on an item-recommendation policy parameterized via W_{π}_{_{T}} (e.g., a corresponding cumulative-success value). If such a comparison indicates that a benefit in the cumulative success is associated with the updated item-recommendation policy, as compared to the current item-recommendation policy, then the updated item-recommendation policy may be deployed in a “live” online system.

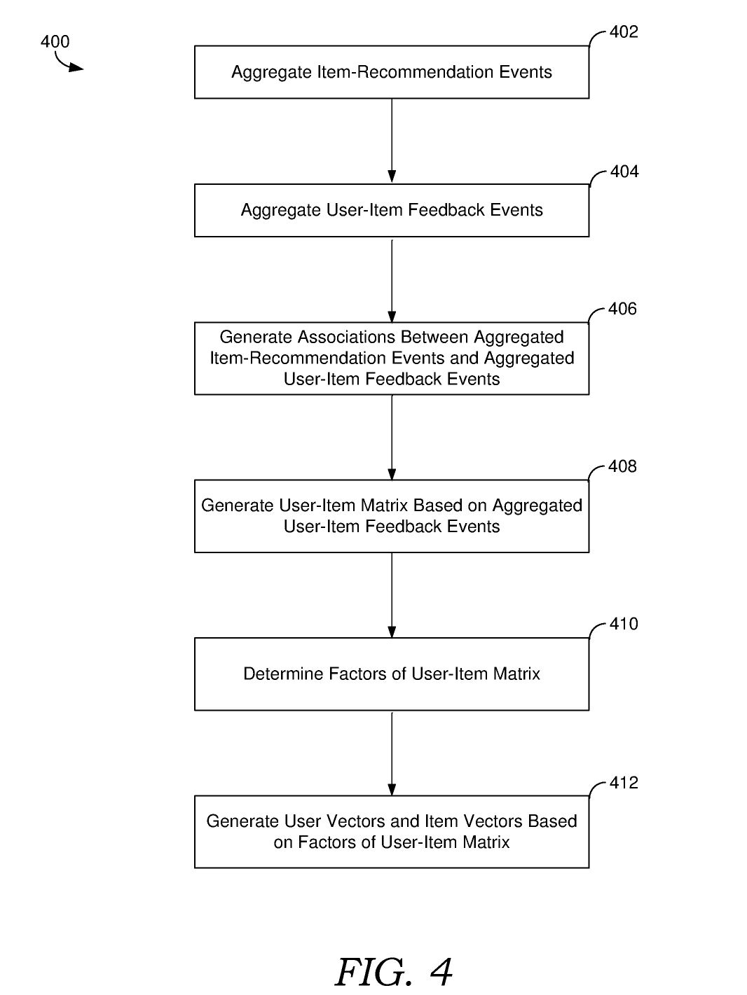

Turning to FIG. 3, a flow diagram is provided that illustrates one example of a process 300 for providing item recommendations based on a cumulative-success metric (CSM) in accordance with an embodiment of the present disclosure. In one exemplary, but non-limiting embodiment, various portions of FIG. 2A may be implemented on one or more devices, such as but not limited to server 106 of FIG. 1. For instance, server 106 may host and/or implement one or more of recommendation policy generator/updater 210, recommendation engine 250, and/or recommendation policy evaluator 220. Initially, as shown in block 302, user-item data is aggregated. Various components of recommendation policy generator/updater 210, such as but not limited to user-item data aggregator 212, may be employed to aggregate user-item data. Various embodiments of aggregating user-item data are discussed throughout, including at least in conjunction with process 400 of FIG. 4. The user-item data may be stored and/or retrieved from storage, such as but not limited to storage 230, via network 110.

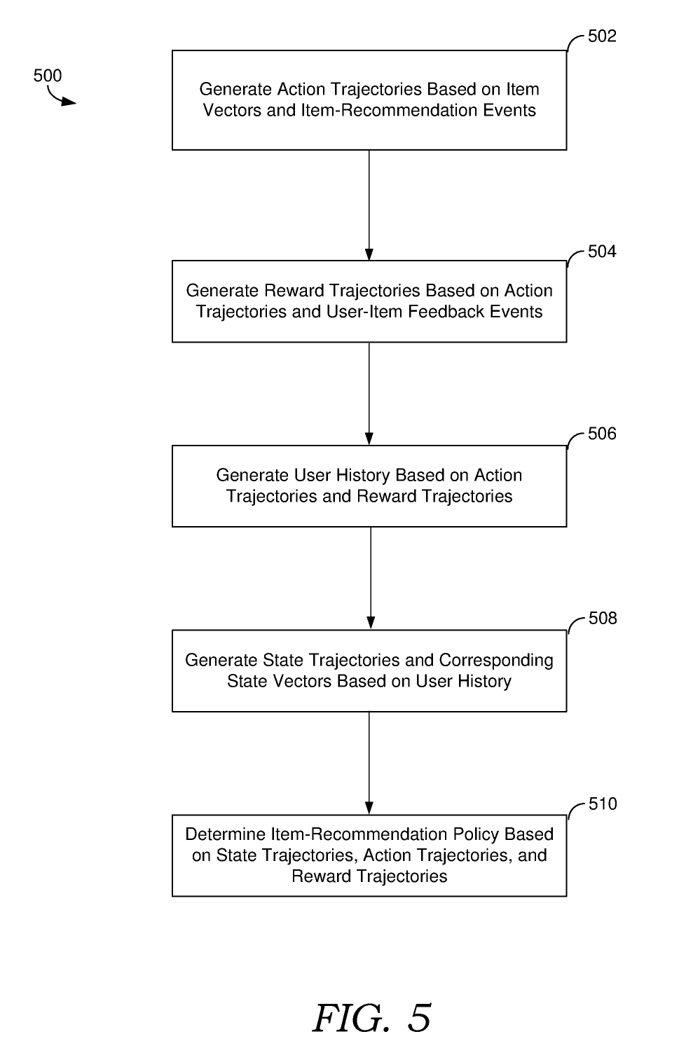

At block 304, user latent-features and item latent-features are determined based on the aggregated user-item data. Various components of recommendation policy generator/updater 210, such as but not limited to user and item latent-feature detector 214, may be employed to determine the user and item latent-features. Various embodiments of determining user latent-features and item latent-features are discussed in conjunction with at least process 400. At block 306, a reinforcement model (RM) is generated based on the user and item latent-features. Recommendation policy learner 216 may be employed to generate Various embodiments for generating an RM are discussed throughout, including at least in conjunction with process 500 of FIG. 5. At block 308, one or more item-recommendation policies are determined and/or generated based on the RM. Various embodiments for determining and/or generating item-recommendation policies are discussed in conjunction with at least process 500. Various components of recommendation generator/updater 210, such as but not limited to recommendation policy learner 216, may be employed to carry out at least portions of blocks 306 and 308.

At block 310, a recommendation request may be received. For instance, a recommendation request may be received from a user device, such as but not limited to user device 102a of FIG. 1, via network 110. For instance, one or more components of recommendation engine 250 of FIG. 2A, such as recommendation-request detector 252, may be provided a recommendation request from a user device, such as any user device 102a-102n of FIG. 1. At block 312, in response to the received recommendation request, an item recommendation may be provided. For instance, the item recommendation may be provided to the user device that provided the recommendation request, via network 110. The item recommendation may be determined and/or generated based on the one or more item-recommendation policies. The item recommendation may be encoded in an item-recommendation event. In one exemplary embodiment, recommendation generator 254 may generate an item recommendation, and recommendation provider 256 provides the item recommendation to the user device.

At block 314, a user-item feedback event may be received in response to the provided recommendation. For instance, a user may provide, via the user device and network 110, a user-item interaction, such as but not limited to a purchase or review, and/or select an item indicated in the item recommendation. The provided user-item interaction may be encoded in a user-item event and stored in storage 230. At block 316, the user-item data is updated to include the item-recommendation event and the user-item feedback event. For example, item-recommendation events 234 and user-item feedback events 236 of user-item data 232 of FIG. 2A, may be updated at block 316. At block 318, user and item latent-features may be updated based on the updated user-item data. Furthermore, the RM, and one or more item-recommendation policies may be updated based on the updated user-item data. Various embodiments for updating the user and item latent-features, RM, and item-recommendation policies are discussed in conjunction with FIGS. 4-5. In various embodiments, one or more components of recommendation policy generator/updater 210 may be employed to carry out at least portions of block 318. Process 300 may return to block 310 to receive additional recommendation requests.

Turning to FIG. 4, a flow diagram is provided that illustrates process 400 for aggregating user-item data and determining user and item latent-features based on the aggregated user-item data in accordance with embodiments of the present disclosure. Various components of recommendation policy generator/updater 210, such as but not limited to user-item data aggregator and/or user and item latent feature detector 214 may be employed to carry out at least portions of process 400. Initially, as shown in block 402, item-recommendation events may be aggregated, via user-item data aggregator 212. In block 404, user-item feedback events may be aggregated, via user-item data aggregator 212. Aggregated item-recommendation events 234 and user-item feedback events 236 may be stored, accessed, updated, and/or retrieved at blocks 402 and/or 404.

In block 406, associations, correspondences, and/or correlations between the aggregated item-recommendation events and the aggregated user-item feedback events may be generated and/or determined. At block 408, a user-item matrix may be generated and/or determined based on the aggregated user-item feedback events. In block 410, factors of the user-item matrix may be determined. For instance, various matrix factorization (MF) and/or matrix decomposition processes, methods, and/or techniques may be employed at block 410. At block 412, user vectors and item vectors may be generated based on the factors of the user-item matrix. Various portions of block 406-412 may be performed by components of recommendation policy generator/updater 210, such as user and item latent-feature detector.

Turning to FIG. 5, a flow diagram is provided that illustrates process 500 for generating a reinforcement model (RM) and generating and/or determining an item-recommendation policy based on the RM in accordance with embodiments of the present disclosure. Various components of recommendation policy generator/updater 210, such as but not limited to recommendation policy learner 216 may be employed to carry out at least portions of process 400.

Initially, as shown in block 502, action trajectories may be generated for each user. The action trajectories for a particular user may be based on item vectors and item-recommendation events associated with the particular user. At block 504, reward trajectories may be generated for each user. The reward trajectories for the particular user may be based on the action trajectories for the user, as well as user-item feedback events associated with the particular user. At block 506, a user history may be generated for each user based on the action trajectories and the reward trajectories for the user. At block 508, the state trajectories and corresponding state vectors for each user are generated based on the user history for each user. At block 510, one or more item-recommendation policies are generated based on the state trajectories, action trajectories, and the rewards trajectories for each user. In at least one embodiment, an item-recommendation policy is generated for each user based on the corresponding trajectories within the spaces of the RM.

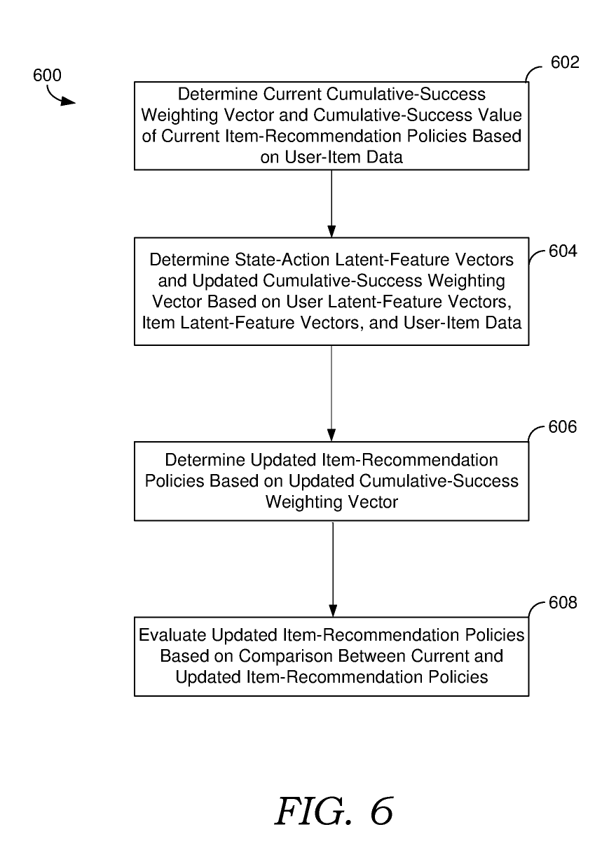

Turning to FIG. 6, a flow diagram is provided that illustrates process 600 for a workflow to evaluate a cumulative success of a current item-recommendation policy and evaluate the performance of an updated item-recommendation policy, as compared to the current item-recommendation policy in accordance with embodiments of the present disclosure. Various components of recommendation policy evaluator 220 of FIG. 2A may be employed to carry out at least portions of process 400.

At block 602, the current cumulative-success weighting vector and the cumulative-success value of the current item-recommendation policies (i.e., the behavior policy) may be determined based on the user-item data. At least portions of block 602 may be enabled by on-policy analyzer 222. At block 604, the state-action latent-feature vectors and an updated cumulative-success weighting vector may be determined. In various embodiments, the state-action latent-feature vectors may be determined based on combinations and/or concatenations of the user latent-feature vectors and the item latent-feature vectors. In some embodiments, the updated cumulative-success weighting vector may be based on the state-action latent-feature vectors and the user-item data. For instance, action-value function generator 224 may be employed to carry out portions of block 604.

At block 606, an updated item-recommendation policy (i.e., a target policy) may be determined and/or generated based on the updated cumulative-success weighting vector. In some embodiments, the updated item-recommendation policy may be generated based on a parameterized form of a recommendation policy. At least portions of block 606 may be enabled by off-policy learner 226. At block 608, the updated item-recommendation policy is evaluated. For instance, the updated item-recommendation policy may be evaluated based on a comparison between the current and the updated item-recommendation policies. At least portions of block 608 may be performed and/or enabled by off-policy analyzer 228.

Accordingly, we have described various aspects of technology that provides item recommendations to users based on an expectation of the cumulative success of the recommendations. It is understood that various features, sub-combinations, and modifications of the embodiments described herein are of utility and may be employed in other embodiments without reference to other features or sub-combinations. Moreover, the order and sequences of steps shown in the example methods 300, 400, 500, and 600 are not meant to limit the scope of the present disclosure in any way, and in fact, the steps may occur in a variety of different sequences within embodiments hereof. Such variations and combinations thereof are also contemplated to be within the scope of embodiments of this disclosure.

Having described various implementations, an exemplary computing environment suitable for implementing embodiments of the disclosure is now described. With reference to FIG. 7, an exemplary computing device is provided and referred to generally as computing device 700. The computing device 700 is but one example of a suitable computing environment and is not intended to suggest any limitation as to the scope of use or functionality of embodiments of the disclosure. Neither should the computing device 700 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the disclosure may be practiced in a variety of system configurations, including handheld devices, consumer electronics, general-purpose computers, more specialty computing devices, or similar devices. Embodiments of the disclosure may also be practiced in distributed computing environments where tasks are performed by remote-processing devices that are linked through a communications network. In a distributed computing environment, program modules may be located in both local and remote computer storage media including memory storage devices.

With reference to FIG. 7, computing device 700 includes a bus 710 that directly or indirectly couples the following devices: memory 712, one or more processors 714, one or more presentation component(s) 716, one or more input/output (I/O) port(s) 718, one or more I/O components 720, and an illustrative power supply 722. Bus 710 represents what may be one or more busses (such as an address bus, data bus, or combination thereof). Although the various blocks of FIG. 7 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more embodiments of the present disclosure. Distinction is not made between such categories as “workstation,” “server,” “laptop,” “handheld device,” or other such devices, as all are contemplated within the scope of FIG. 7 and with reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, or other such memory and/or storage devices. Computing device 700 includes one or more processors 714 that read data from various entities such as memory 712 or I/O components 720. Presentation component(s) 716 presents data indications to a user or other device. In some implementations, presentation component 270 of system 200 may be embodied as a presentation component 716. Other examples of presentation components may include a display device, speaker, printing component, vibrating component, and the like.

The I/O port(s) 718 allow computing device 700 to be logically coupled to other devices, including I/O components 720, some of which may be built in. Illustrative components include a microphone, joystick, game pad, satellite dish, scanner, printer, and wireless device, as well other such I/O components. The I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

Some embodiments of computing device 700 may include one or more radio(s) 724 (or similar wireless communications components). The radio 724 transmits and receives radio or wireless communications. The computing device 700 may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short-range and long-range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computerized system comprising:
one or more processors; and
computer storage memory having computer-executable instructions stored thereon which, when executed by the one or more processors, implement a method comprising:
automatically determining user features for each of a plurality of users based on a plurality of feedback events, wherein each of the plurality of feedback events includes a previous user-item reward that indicates a preference previously provided by one of the plurality of users for one of a plurality of items;
automatically determining item features for each of the plurality of items based on the plurality of feedback events;
determining one or more recommendation policies based on a cumulative metric that includes an expected value for an accumulation of a plurality of stochastic user-item rewards associated with a plurality of subsequent recommendations, wherein the accumulation of the plurality of stochastic user-item rewards is based on the user features, the item features, and the previous user-item rewards included in the plurality of feedback events; and
providing a first user of the plurality of users a first recommendation that includes an indication of at least a first item of the plurality of items, wherein the first recommendation is based on the one or more recommendation policies, the user features for the first user, and the item features for the first item.

2. The system of claim 1, wherein the method further comprising:
generating a user-item matrix that includes at least a portion of the previous user-item rewards;
determining a first matrix and a second matrix, wherein the first matrix is a first factor if the user-item matrix and the second matrix is a second factor of the user-item matrix;
determining the user features for each of the plurality of users based on the first matrix; and
determining the item features for each of the plurality of items based on the second matrix.

3. The system of claim 1, wherein the method further comprises:
generating an ordered set of action vectors based on recommendations that were previously provided to the first user, wherein each of the action vectors are based on item features for a portion of the plurality of items that is indicated in the recommendations;
generating an ordered set of the previous user-item rewards that includes previous user-item rewards that were previously provided by the first user and in response to the recommendations that were previously provided to the first user;
generating an ordered set of state vectors based on the user features of the first user, the ordered set of action vectors, and the ordered set of the previous user-item rewards;
generating a reinforcement-learning model based on the ordered set of action vectors, the ordered set of the previous user-item rewards, and the ordered set of state vectors; and
determining the one or more recommendation policies based on the reinforcement-learning model.

4. The system of claim 3, wherein the method further comprises:
generating a history for the first user based on a combination of the ordered set of action vectors and the ordered set of the previous user-item rewards; and
generating the ordered set of state vectors based on the history for the first user.

5. The system of claim 1, wherein the cumulative metric includes a discount parameter that reduces the accumulation of the stochastic user-item rewards based on temporal distance for each of the stochastic user-item rewards.

6. The system of claim 1, wherein determining the one or more recommendation policies is based on a Markov Decision Process (MDP) that increases the cumulative metric.

7. The system of claim 6, wherein an action space of the MDP is based on the item features for each of the plurality of items and a state space of the MDP is based on the user features of each of the plurality of users.

8. The system of claim 1, wherein the method further comprises:
generating a one-to-one association between the plurality of feedback events and a plurality of recommendation events, wherein a first feedback event of the plurality of feedback events is in response to a first recommendation event of the plurality of recommendation events that is associated with the first feedback event; and
determining each of the plurality of stochastic user-item rewards associated with the plurality of subsequent recommendations based on the one-to-one association between the plurality of feedback events and the plurality of recommendation events.

9. The system of claim 1, wherein the item features of each of the plurality of items are item latent-features and the user features of each of the plurality of users are user latent-features that indicate a user's preference for the item latent-features of each of the plurality of items.

10. A computerized system comprising:
one or more processors; and
computer storage memory having computer-executable instructions stored thereon which, when executed by the one or more processors, implement a method comprising:
determining a current cumulative value that is associated with a current recommendation policy based on an on-policy analysis of user-item data that includes a plurality of previous recommendation events and a plurality of associated feedback events for a plurality of users and a plurality of items;
determining an action-value function based on state-action pairs based on the user-item data;
generating an updated recommendation policy based on the action-value function and an off-policy analysis of the user-item data;
generating a comparison of the current cumulative value and an updated cumulative value that is associated with the updated recommendation policy and the off-policy analysis of the user-item data; and
in response to the comparison of the current cumulative value and the updated cumulative value, deploying the updated recommendation policy.

11. The system of claim 10, wherein the method further comprises:
generating a state vector for each state of each of the state-action pairs;
generating an action vector for each action of each of the state-action pairs;
generating a state-action vector for each state-action pair based on a combination of a corresponding state vector and a corresponding action vector; and
generating the action-value function based on the state-action vectors.

12. The system of claim 11, wherein the current recommendation policy is based on the state-action vectors and a first weighting vector and the updated recommendation policy is based on the state-action vectors and a second weighting vector.

13. A method for recommending items, comprising:
aggregating user-item data that includes a plurality of recommendation data structures (DSs) and a plurality of feedback DSs, wherein each of the plurality of recommendation DSs encodes a previous recommendation, which was provided to one of a plurality of users, for at least one of a plurality of items, and wherein each of the plurality of feedback DSs encodes a corresponding preference of the one of the plurality of users for the at least the one of the plurality of items;
generating a plurality of user DSs based on the plurality of feedback DSs, wherein each of the plurality of user DSs encodes user latent-features of one of the plurality of users;
generating a plurality of item DSs based on the plurality of feedback DSs, wherein each of the plurality of item DSs encodes item latent-features of one of the plurality of items DSs;
generating a decision-process DS based on the plurality of recommendation DSs, the plurality of feedback DSs, the plurality of user DSs, and the plurality of items; and
generating one or more recommendation policies based on the decision-process DS and a cumulative metric that includes an expected value for an accumulation of a plurality of rewards, wherein the plurality of rewards is based on the plurality of recommendation DSs and the plurality of feedback DSs.

14. The method of claim 13, further comprising:
generating a matrix based on the plurality of feedback DSs;
determining a first factor of the matrix and a second factor of the matrix;
determining the user latent-features based on the first factor of the matrix; and
determining the item latent-features based on the second factor of the matrix.

15. The method of claim 13, further comprising:
for each user of the plurality of users, generating an action trajectory based sequences of the plurality of recommendation DSs to include in the decision-process DS, wherein the action trajectories are within an action space of a reinforcement model (RM) that includes the decision-process DS;
for each user of the plurality of users, generating a reward trajectory based on the action trajectory for the user and corresponding sequences of the plurality of feedback DSs to include in the decision-process DS, wherein the reward trajectories are within a reward space of the RM;
for each user of the plurality of users, generating a state trajectory based on the user DS for the user, the action trajectory for the user, and the reward trajectory for the user to include in the decision-process DS, wherein the state trajectories are within a state space of the RM; and
generating the one or more recommendation policies based on the action trajectories, the award trajectories, and the state trajectories.

16. The method of claim 15, further comprising:
for each of the plurality of users, generating a history based on a concatenation of the action trajectory for the user and the reward trajectory for the user; and
for each user of the plurality of users, generating the state trajectory based on factors of the history for the user.

17. The method of claim 13, wherein the cumulative metric includes a discount parameter that reduces the accumulation of the stochastic user-item rewards based on temporal distance for each of the stochastic user-item rewards.

18. The method of claim 13, wherein generating the one or more recommendation policies is based on increasing an evaluation of the cumulative metric with respect to other recommendation policies.

19. The method of claim 13, further comprising:
employing the one or more recommendation policies to provide a first user of the plurality of users a first recommendation based on the user latent-features of the first user.

20. The method of claim 13, wherein the user latent-features of each of the plurality of users indicate a preference for the item latent-features.
